(19) United States
(12) Patent Application Publication
(10) Pub. No.: US 2009/0282104 A1
(43) Pub. Date: Nov. 12, 2009

(54) SYSTEM AND METHOD FOR INDICATING AVAILABILITY

(76) Inventors: Patrick Joseph O'Sullivan, Ballsbridge (IE); Sean Callanan, Churchtown (IE); Gary Denner, Celbridge (IE); Carol Zimmet, Boxborough, MA (US)

Correspondence Address: HOLLAND & KNIGHT, 10 ST. JAMES AVENUE, BOSTON, MA, 02116-3889, US

(21) Appl. No.: 12/118,007

(22) Filed: May 9, 2008

(51) Int. Cl. G06F 15/16

(52) U.S. Cl. 709/204

(57) ABSTRACT

A method and computer program product for analyzing a plurality of relationships of a user. A social network of the user is defined based upon, at least in part, at least a portion of the plurality of relationships of the user. The social network identifies one or more relationship users. A relationship score is associated with the one or more relationship users. An instant messaging availability status of the user is indicated to the one or more relationship users based upon, at least in part, the relationship score associated with the one or more relationship users.

### TECHNICAL FIELD

This disclosure relates to communications applications, and more particularly to an availability indicator for instant messaging applications.

### BACKGROUND

In the present internet and electronic communication age, instant messaging is an increasingly prevalent means of communication, because it enables users to conduct a live conversation with other users who are logged in to the instant messaging application. Unfortunately, some individuals who appear in a buddy list or contacts list as logged in may be plagued by continuous instant messages and other contacts over the course of the day. Frequently such individuals may intentionally choose not to log into the application at all in order to avoid the often unnecessary interruptions. This may be problematic, both for the individual who has not logged in, and therefore cannot utilize instant messaging as a convenient communication medium, as well as for those who need to reach that individual for legitimate reasons. Thus, it would be desirable to provide a control mechanism allowing an instant messaging user to selectively broadcast his availability only to those other users who are more likely to only give rise to legitimate interruptions.

### SUMMARY OF THE DISCLOSURE

In a first implementation, a method includes analyzing a plurality of relationships of a user. A social network of the user is defined based upon, at least in part, at least a portion of the plurality of relationships. The social network identifies one or more relationship users. A relationship score is associated with the one or more relationship users. An instant messaging availability status of the user is indicated to the one or more relationship users based upon, at least in part, the relationship score associated with the one or more relationship users. The one or more relationship users may generally include any individuals with whom the user engages in collaborative interactions. For example, relationship users may include, but are not limited to individuals with whom the user may exchange email communications, instant messaging chats, and voice communications, as well as individuals that engage in web conferences, project collaborations, scheduled calendar events with the user, or who are included within a work group (e.g., team or department) along with the user.

One or more of the following features may be included. The plurality of relationships of the user may include one or more of: email communications, instant messaging chats, web conferences, project collaborations, voice communications, scheduled calendar events, and travel itineraries. The relationship score may be based upon, at least in part, one or more predefined preferences defined by one or more of the user and an administrator. The relationship score may be based upon, at least in part, a temporal parameter associated with each of the plurality of relationships of the user. The temporal parameter associated with each of the plurality of relationships of the user may be defined in terms of one or more of days, weeks, months, and years. The relationship score may be based upon, at least in part, a weighting factor for the plurality of relationships of the user.

The user may define a threshold relationship score, and the instant messaging availability status of the user may be indicated if the relationship score associated with the one or more relationship users is greater than the threshold relationship score. One or more relationship users capable of viewing the instant messaging availability status of the user notwithstanding an associated relationship score may be defined. One or more relationship users restricted from viewing the instant messaging availability status of the user notwithstanding an associated relationship score may be defined. The relationship score of the one or more relationship users may be updated. The instant messaging availability status of the user may be indicated to the one or more relationship users based upon, at least in part, the updated relationship score of the one or more relationship users.

According to another implementation, a computer program product resides on a computer readable medium having a plurality of instructions stored on it. When executed by a processor, the instructions cause the processor to perform operations including analyzing a plurality of relationships of a user. The instructions further cause the processor to define a social network of the user based upon, at least in part, at least a portion of the plurality of relationships. The social network may identify one or more relationship users. The instructions further cause the processor to associate a relationship score with the one or more relationship users. The instructions further cause the processor to indicate an instant messaging availability status of the user to the one or more relationship users based upon, at least in part, the relationship score associated with the one or more relationship users.

One or more of the following features may be included. The plurality of relationships of the user may include one or more of: email communications, instant messaging chats, web conferences, project collaborations, voice communications, scheduled calendar events, and travel itineraries. The relationship score may be based upon, at least in part, one or more predefined preferences defined by one or more of the user and an administrator. The relationship score may be based upon, at least in part, a temporal parameter associated with each of the plurality of relationships of the user. The temporal parameter associated with each of the plurality of relationships of the user may be defined in terms of one or more of days, weeks, months, and years. The relationship score may be based upon, at least in part, a weighting factor for the plurality of relationships of the user.

The user may define a threshold relationship score, and instructions may be included for indicating the instant messaging availability status of the user if the relationship score associated with the one or more relationship users is greater than the threshold relationship score. One or more relationship users capable of viewing the instant messaging availability status of the user notwithstanding an associated relationship score may be defined. One or more relationship users restricted from viewing the instant messaging availability status of the user notwithstanding an associated relationship score may be defined. Instructions may be included for updating the relationship score of the one or more relationship users. Instructions may be included for indicating the instant messaging availability status of the user to the one or more relationship users based upon, at least in part, the updated relationship score of the one or more relationship users.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts an availability indicator process and a relationship application coupled to a distributed computing network.

FIG. 2 is a flowchart of a process executed by the availability indicator process of FIG. 1.

FIG. 3 diagrammatically depicts an instant messaging contacts list rendered by the relationship application and/or the availability indicator process of FIG. 1.

FIG. 4 diagrammatically depicts an instant messaging contacts list rendered by the relationship application and/or the availability indicator process of FIG. 1.

FIG. 5 diagrammatically depicts an instant messaging contacts list rendered by the relationship application and/or the availability indicator process of FIG. 1.

FIG. 6 diagrammatically depicts an instant messaging contacts list rendered by the relationship application and/or the availability indicator process of FIG. 1.

### DETAILED DESCRIPTION

### System Overview

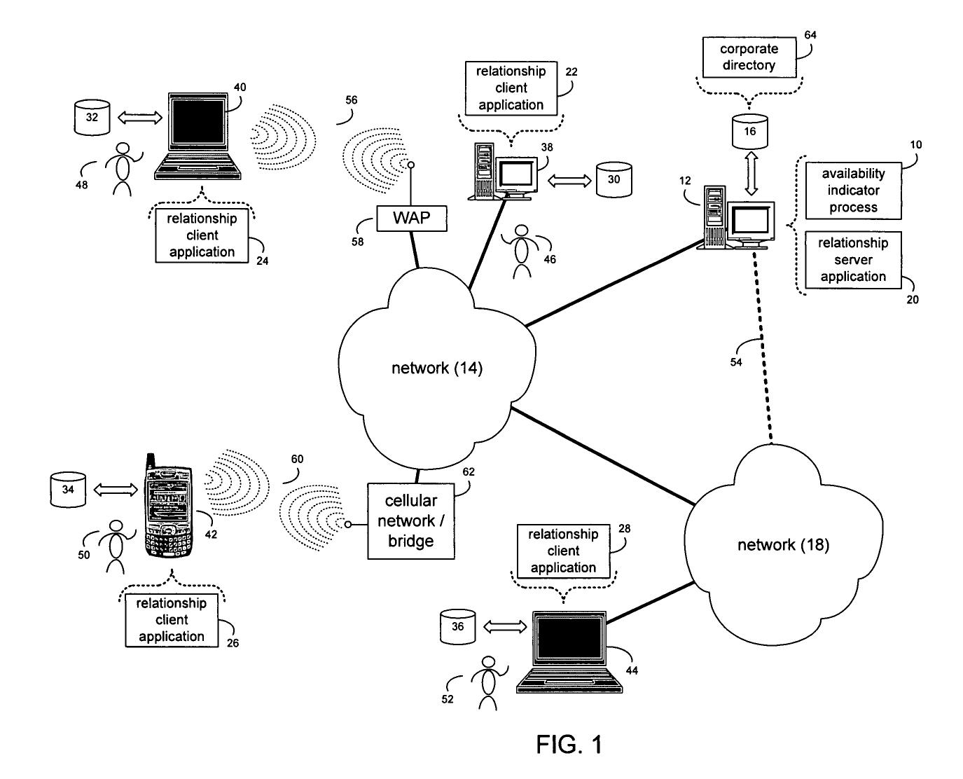

Referring to FIG. 1, there is shown availability indicator process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. In addition/as an alternative, availability indicator process 10 may reside on and may be executed by one or more client electronic devices, such as a personal computer, a notebook computer, a personal digital assistant, and a data enabled cellular phone, for example.

As will be discussed in greater detail below, availability indicator process 10 may analyze a plurality of relationships of a user. A social network of the user may be defined based upon, at least in part, at least a portion of the plurality of relationships. The social network may identify one or more relationship users. A relationship score may be associated with the one or more relationship users. An instant messaging availability status of the user is indicated to the one or more relationship users based upon, at least in part, the relationship score associated with the one or more relationship users.

The instruction sets and subroutines of availability indicator process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more relationship server applications (e.g., relationship server application 20), examples of which may include but are not limited to email server applications that may include calendar and/or scheduling modules or components (e.g., Lotus Domino™ Server and Microsoft Exchange™ Server), instant messaging server applications (e.g., IBM Lotus Sametime™, Microsoft Office Live Communications Server™, Jabber XCP™, and AOL Instant Messenger™), voice-over IP server applications or PBX telephone systems. Relationship server application 20 may interact with relationship client applications 22, 24, 26, 28, e.g., allowing email to be exchanged, instant message chats to be carried out, meetings and events to be scheduled, and voice calls to be placed, for example. Examples of relationship client applications may include, but are not limited to, email client applications that may include calendar and/or scheduling modules (e.g., Lotus Notes™ and Microsoft Outlook™), instant messaging client applications (e.g., AOL Instant Messenger™, IBM Lotus Sametime™, Google Talk™), voice-over IP client applications, and softphone applications. Availability indicator process 10 may be a stand-alone application that interfaces with relationship server application 20 or may be an applet/application that is executed within relationship server application 20.

The instruction sets and subroutines of relationship server application 20, which may be stored on storage device 16 coupled to server computer 12, may be executed by one or more processors (not shown) and one or more memory architectures (not shown) incorporated into server computer 12.

As mentioned above, in addition/as an alternative to being a server-side application residing on server computer 12, the availability indicator process may be a client-side application (not shown) residing on one or more client electronic device 38, 40, 42, 44 (e.g., stored on storage devices 30, 32, 34, 36, respectively). As such, the client-side availability indicator process may be a stand-alone application that interfaces with a relationship client application (e.g., relationship client applications 22, 24, 26, 28), or may be an applet/application that is executed within a relationship client application (e.g., relationship client applications 22, 24, 26, 28). As such, the availability indicator process may be a client-side process, a server-side process, or a hybrid client-side/server-side process, which may be executed, in whole or in part, by server computer 12, or one or more of client electronic devices 38, 40, 42, 44.

The instruction sets and subroutines of relationship client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using relationship client applications 22, 24, 26, 28, users 46, 48, 50, 52 may engage in relationship activities (e.g., send/receive email communications, conduct instant messaging chats, schedule calendar events, conduct telephone conversations, and similar activities). Engaging in relationship activities may include accessing relationship server application 20.

Users 46, 48, 50, 52 may access relationship server application 20 directly through the device on which the relationship client application (e.g., relationship client applications 22, 24, 26, 28) is executed, namely client electronic devices 38, 40, 42, 44, for example. Users 46, 48, 50, 52 may access relationship server application 20 directly through network 14 or through secondary network 18. Further, server computer 12 (i.e., the computer that executes relationship server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Availability Indicator Process

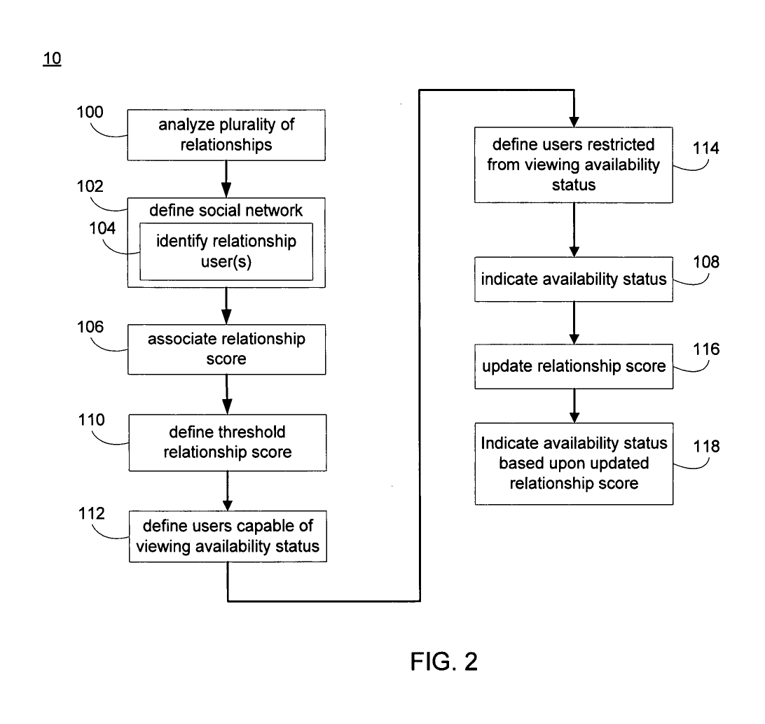

Referring also to FIG. 2, availability indicator process 10 may analyze 100 a plurality of relationships of a user (e.g., user 46), and may define 102 a social network based upon, at least in part, at least a portion of the plurality of relationships of the user. Defining 102 the social network of the user may include identifying 104 one or more relationship users. Availability indicator process 10 may associate 106 a relationship score with each of the one or more relationship users. An instant messaging availability status of the user may be indicated 108 to the one or more relationship users based upon, at least in part, the relationship score associated 106 with the one or more relationship users.

The plurality of relationships of the user may include, for example, one or more of: email communications, instant messaging chats, web conferences, project collaborations, voice communications, scheduled calendar events, travel itineraries, and inclusion in a work group (e.g., team or department). For example, user 46 may send and/or receive an email to/from user 48. Additionally, user 46 may conduct an instant messaging chat with user 50. User 46 may schedule a meeting with user 52. The scheduled meeting with user 52 may be explicit (e.g., a meeting may be scheduled between user 46 and user 52, or user 46 may accept a meeting schedule from user 52) or may be implicit (e.g., user 46 and user 52 may each be scheduled for a meeting at the same time and place). Furthermore, user 46 may initiate and/or receive a telephone call from another user (e.g., which may be logged by an enterprise telephone system or a caller ID system/module). Users 46, 48, and 50 may also take a business trip together (e.g., evidenced based on group travel arrangements, commonly scheduled events in a calendar application, or the like).

Continuing with the above-stated example, the plurality of relationships of user 46 may be conducted using relationship client application 22 (alone or in conjunction with one or more of relationship server application 20 and relationship client applications 24, 26, 28). For example, the plurality of relationships may include interaction between relationship client application 22 and one or more of relationship client applications 24, 26, 28 via relationship server application 20. Continuing with the above-stated example, user 46 may send/receive the email to/from user 48 via an email application. Similarly, user 46 may conduct the instant messaging chat with user 50 via an instant messaging application. User 46 may initiate/receive a telephone conference call via a voice communication application, and may schedule a meeting with user 52 via a calendar/scheduling application. Various other relationship activities and applications may also be used.

Availability indicator process 10 may define 102 one or more social networks for the user based upon at least a portion of the plurality of relationships of the user. The social networks defined 102 for the user may identify 104 one or more relationship users. In part, the social network defined 102 for user 46 may include people (i.e., relationship users, e.g., users 48, 50, 52) with whom user 46 has a relationship, e.g., as indicated by email, instant messaging, and voice communications, and by common appointments and travel arrangements, as discussed above. Additionally/alternatively, user 46's social network may include people with whom the user works and has an organizational relationship, e.g., based upon, at least in part, a corporate directory (e.g., corporate directory 64 residing on server computer 12), or similar directory. Corporate directory 64 may indicate, for example, associations by department, work group, and the like.

Availability indicator process 10 may associate 106 a relationship score with the one or more relationship users (e.g., users 48, 50, 52). The relationship score may be based upon a variety of parameters, which may include, for example, a frequentness and/or type of contacts with the user and/or a relationship user's organizational relationship to the user (e.g., supervisor or subordinate within a given work group or department). For example, availability indicator process 10 may associate 106 a relatively higher relationship score with a relationship user who often contacts the user by email, phone and/or instant messenger. Similarly, availability indicator process 10 may associate 106 a relatively lower relationship score with a relationship user that less frequently contacts the user. Similarly, availability indicator process 10 may associate a higher relationship score with relationship users having a relatively close organizational proximity to the user (e.g., the user's immediate supervisor and/or subordinates within a work group). The relationship score may decrease for relationship users having a greater organizational distance from the user (e.g., members of other departments, and the like).

The relationship score associated 106 with the one or more relationship users may be based upon, at least in part, one or more predefined preferences. The one or more predefined preferences may be defined by one or more of the user and an administrator. For example, user 46 may consider different attributes of the various relationships as being more or less important in deciding whether to allow a relationship user (e.g., one or more of users 48, 50, 52) to view user 46 as available for instant messaging. Such preferences may include, for example, frequency of contact, type of contact, organizational relationship, who initiated the contact (e.g., how many of the contacts were initiated by user 46 as compared to how many of the contacts were initiated by the relationship user). Various additional/alternative preferences may be defined as associating 106 a relationship score with the one or more relationship users, depending upon design criteria and user preference.

Continuing with the above example, the relationship score may be based upon, at least in part, a temporal parameter associated with each of the plurality of relationships of the user. The temporal parameter may, for example, be based upon, at least in part, how recently the user has engaged in a relationship with the one or more relationship users. For example, a year ago user 46 may have worked with user 52 on a common project. During the course of the project, user 46 and user 52 may have exchanged hundreds of emails and instant messages. However, in the last year since working on the project together, user 46 may not have exchanged any email or instant messages with user 52. Similarly, over the past two months user 46 may have exchanged two or three emails a week with user 48. While the volume of communication between user 46 and user 52 may be greater than the volume of communication between user 46 and user 48, the communications between user 46 and user 48 occurred more recently than the communications between user 46 and user 52. As such, a higher relationship score may be associated with user 48 than with user 52, based upon a temporal parameter indicating the recentness of communication. The relationship score may decrease gradually as each of the plurality of relationships becomes less recent with the passage of time.

The temporal parameter associated with each of the plurality of relationships of the user may be defined in terms of one or more of days, weeks, months, and years. Accordingly, the user and/or administrator may define the desired level of granularity when considering the recentness of the relationship. For example, user 46 may typically be involved in projects lasting three months or more with the same group of individuals. While working on a project, user 46 may exchange emails and instant messages on a daily basis with the other individuals on the project. As such, anyone that user 46 has not exchanged email or instant messages with in the last week is likely not part of the current project (e.g., may have been involved in a past project) to which user 46 is assigned. User 46 may, therefore, consider any relationship that has not been active (e.g., not email or instant message exchanges, not commonly scheduled meetings, or the like) to be “stale” and, therefore less important. As such, the relationship score associated 106 with any relationship user may decrease as the recentness of the relationship decreases beyond a week. The level of granularity (e.g., the temporal parameter) may vary according to user preference and design criteria. Additionally, different temporal parameters may be defined for different relationships (e.g., email, instant messages, meetings, voice calls, and the like).

Continuing with the above example, the relationship score may be based upon, at least in part, a weighting factor for the plurality of relationships of the user. As discussed above, the plurality of relationships of the user may include, e.g., emails, instant messages, meetings, and the like. The different types of relationships may be assigned a weighting factor. For example, user 46 may frequently be required to attend meetings have a large number of attendees, with whom user 46 otherwise does not interact. As such, user 46 may not consider common attendance at a meeting to give rise to a strong relationship. User 46 may, therefore define a relatively low weighting factor for meetings. A relationship score associated 106 with a relationship user who only attends common meetings with user 46 (e.g., does not engage in other contact with user 46) may be relatively low. In a similar manner, user 46 may consider a relationship based upon organization proximity alone (e.g., a relationship with an individual in user 46's department, but with whom user 46 does not other wise interact) to give rise to a relatively weak relationship. As such, user 46 may define a relatively low weighting factor with organizational proximity. A relatively low relationship score may be associated 106 with relationship users for relationships that arise from organizational proximity. Further, user 46 may use the telephone for addressing most important matters. As such, relationships evidenced by telephone calls may be considered important. Telephone relationships may, therefore, have a relatively high weighting factor. Accordingly, a relatively higher relationship score may be associated 106 with a relationship who engages in telephone calls with user 46.

Availability indicator process 10 may enable the user to define 110 a threshold relationship score, and the instant messaging availability status of the user may be indicated 108 if the relationship score associated with the one or more relationship users is greater than the threshold relationship score. Continuing with the above-stated example, a relationship score may be associated 106 with each of the one or more relationship users. The relationship score associated 106 with each of the one or more relationship users may be based upon, at least in part, the type of relationship (e.g., email, instant messaging, attendance at meetings, organization proximity, and the like) as well as user/administrator defined preferences (e.g., temporal parameter and/or weighting factor). The relationship score associated 106 with each of the one or more relationship users may be, e.g., a numerical score. Availability indicator process 10 may allow user 46 to define a minimum relationship score that must be associated with a relationship user. Availability indicator process 10 may indicate 108 user 46 as being available for instant messaging to those relationship users having an associated 106 relationship score above the defined 110 threshold relationship score. Similarly, availability indicator process 10 may not indicate 108 user 46 as being available for instant messaging to those relationship users having an associated 106 relationship score below the defined 110 threshold relationship score.

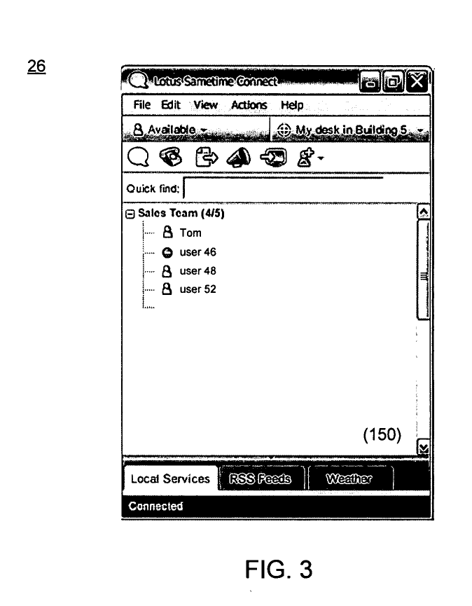

Continuing with the above-stated example, user 46 may define 110 a threshold relationship score of 80. Based upon, at least in part, the type of relationship (e.g., email, instant messaging, attendance at meetings, organization proximity, and the like) as well as user/administrator defined preferences (e.g., temporal parameter and/or weighting factor), user 50 may have an associated 106 relationship score of 70. Continuing with this example, for illustrative purposes, relationship client application 26 may include an instant messaging client application. Relationship client application 26 may allow user 50 to conduct instant messaging chats with various other users. Referring also to FIG. 3, relationship client application 26 may render instant messaging contacts list 150 including one or more instant messaging contacts (e.g., “Tom”, “user 46”, “user 48”, and “user 52”), along with their associated instant messaging availability status.

Availability indicator process 10 may indicate 108 an instant messaging availability status of the user to the one or more relationship users based upon, at least in part, the relationship score of the one or more relationship users. Continuing with the above-stated example, even though user 46 may be logged onto user 46's instant messaging client (e.g., relationship client application 22), based upon, at least in part, user 50 having an associated 106 relationship score (e.g., 70) that is below the defined 110 threshold relationship score (e.g., 80), availability indicator process 10 (e.g., in conjunction with one or more of relationship server application 20 and/or relationship client application 26) may indicate 108 an instant messaging unavailability status for user 46 in instant messaging contacts list 150 for user 50.

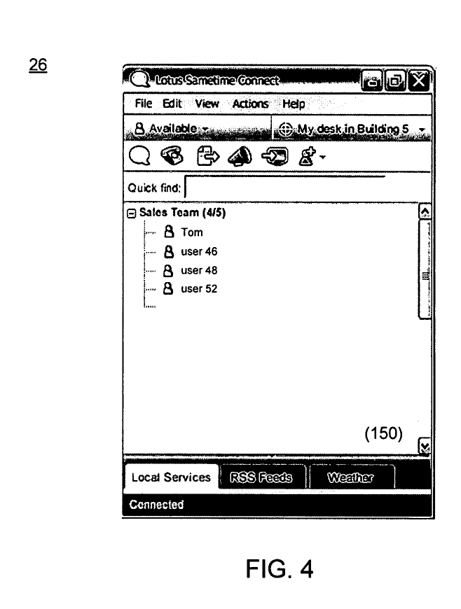

Availability indicator process 10 may allow the user and/or an administrator to define 112 one or more relationship users capable of viewing the instant messaging availability status of the user notwithstanding an associated relationship score. For example, the user may always want his supervisor and/or direct reports to be capable of viewing his instant messaging availability status. Similarly, the user may always want her spouse to be capable of viewing her instant messaging availability status. Availability indicator process 10 may enable the user to define preferences for relationship users that are always capable of viewing the instant messaging availability status of the user. Continuing with the above-stated example, availability indicator process 10 may allow user 46 to define 112 user 50 as being capable of viewing user 46's instant messaging availability status, even though user 50 has an associated 106 relationship score below the defined 110 threshold relationship score. For example, and referring also to FIG. 4, relationship client application 26 (e.g., which, for illustrative purposes, may include an instant messaging client application), may render instant messaging contacts list 150. As shown, notwithstanding user 50 having an associated 106 relationship score below the defined 110 threshold relationship score, availability indicator process 10 (alone or in conjunction with one or more of relationship server application 20 and/or relationship client application 26) may indicate 108 an instant messaging availability status for user 46 in instant messaging contacts list 150 for user 50.

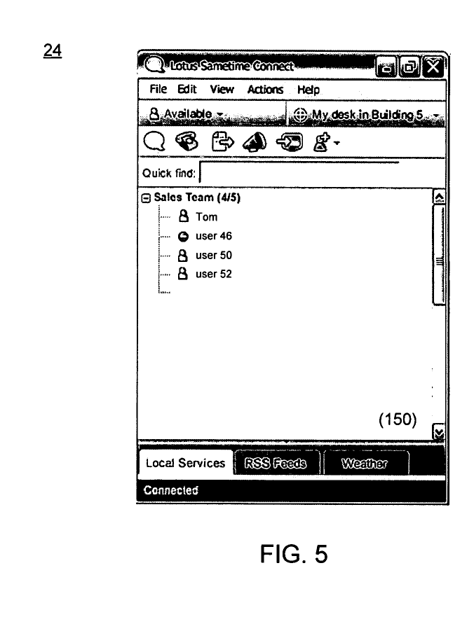

Similarly, availability indicator process 10 may allow the user and/or an administrator to define 114 one or more relationship users restricted from viewing the instant messaging availability status of the user notwithstanding an associated relationship score which may be defined. For example, user 46 may have extensive communications and meetings with user 48, giving rise to a relationship score of 90 (e.g., which may be greater than the defined 110 threshold relationship score of 80) associated 106 with user 48. However, user 48 may be a continual source of interruption to user 46 via instant messaging. Availability indicator process 10 may allow user 46 to define 114 user 48 as being restricted from viewing user 46's instant messaging availability status. Referring also to FIG. 5, based upon, at least in part, user 48 being defined 114 as restricted from viewing user 46's available status for instant messaging, availability indicator process 10 (alone or in conjunction with one or more of relationship server application 20 and/or relationship client application 24) may display user 46 as being unavailable for instant messaging in instant messaging contact list 150 for user 48.

In addition to specifically identified individuals that may always see the user's availability status, or never see the user as being available, as has been described above, availability indicator process 10 may allow the user and/or an administrator to define 112 one or more relationship users capable of viewing the instant messaging availability status of the user notwithstanding an associated relationship score, and/or to define 114 one or more relationship users restricted from viewing the instant messaging availability status of the user notwithstanding an associated relationship score based upon, at least in part, other criteria. For example, the one or more relationship users defined 112 as being capable of, or defined 114 as being restricted from, viewing the availability status of the user, notwithstanding an associated relationship score, may be defined 112, 114 based upon, at least in part, inclusion within a defined group (e.g., a group defined in a directory, e.g., a corporate LDAP directory, or email or instant messaging contacts list), based upon hierarchical position relative to the user (e.g., which may be defined in a corporate LDAP directory), based upon a defined relationship relative to the user (e.g., an instant messaging contact defined as a personal contact rather than a business contact). While various examples of users which may be defined 112, 114 as being able to view/restricted from viewing the users availability status have been discussed, such examples are intended for the purpose of illustration only, and should not be construed as a limitation on the disclosure. Various additional/alternative constructs for defining 112, 114 users may be equally utilized depending upon design criteria and user need.

Availability indicator process 10 may update 116 the relationship score of the one or more relationship users. For example, a user may continually engage in relationships (e.g., email communications, instant message exchanges, attend meetings, and the like) with relationship users. Based upon, at least in part, such ongoing and/or new relationship activities, availability indicator process 10 may update 116 the relationship score associated 106 with the one or more relationship users. Availability indicator process 10 may continually and/or intermittently (e.g., on a predetermined time-wise basis and/or upon the occurrence of a predefined event) update 116 the relationship score associated 106 with the one or more relationship users. Availability indicator process 10 may indicate 118 the instant messaging availability status of the user to the one or more relationship users based upon, at least in part, the updated 116 relationship score of the one or more relationship users.

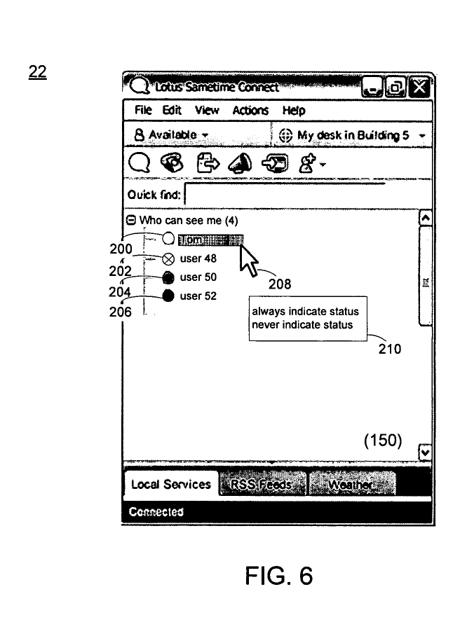

Continuing with the above-stated example, in which availability indicator process 10 may update 116 the relationship score of the one or more relationship users, and referring also to FIG. 6, instant messaging client application 22 (alone or in conjunction with availability indicator process 10) may render contacts list 150 associated with user 46. Contacts list 150 may include the group “Who can see me”, e.g., which may provide a graphic representation of the relationship users (e.g., Tom, user 48, user 50, user 52) and respective capability of the relationship users to view user 46's availability status. Status icons 200, 202, 204, 206 may be associated with each of the relationship users (i.e., with Tom, user 48, user 50, and user 52 respectively) indicating an ability of each relationship user to view the availability of user 46 (e.g., based upon relationship score associated 106 with each relationship user). As mentioned above, the relationship score associated 106 with each of the relationship users may be based upon, at least in part, a temporal parameter. As such, the relationship score may wane as the time since the last interaction increases. Status icons 200, 202, 204, 206 may indicated, for example, a waning relationship score based upon, at least in part, the temporal parameter.

Continuing with the above stated example, status icon 202 may indicate that user 48 is restricted from viewing user 46's instant messaging availability, e.g., based upon user 48 being defined 114 as being restricted from viewing the availability status of user 46. Similarly, status icons 204, 206 may indicate that user 50 and user 52 may view user 46's availability status, with user 52 exhibiting a stronger associated 106 relationship score, e.g., as indicated by solid black status icon 206 associated with user 52, as compared to gray status icon 204 associated with user 50. Further, solid white status icon 200 may indicate that Tom does not have the ability to view the availability status of user 46, based upon an associated 106 relationship score that is below the defined 110 relationship score, e.g., which may be based upon, at least in part, infrequent communications between Tom and user 46. As such, status icons 200, 204, 206 may graphically indicate a waning of a relationship score associated 106 with relationship users Tom, user 50, and user 52 (e.g., based upon, at least in part, the temporal parameter).

Continuing with the above-stated example, based upon the understanding that Tom cannot view user 46's availability status (e.g., as a result of an associated 106 relationship score below the defined 110 threshold relationship score), availability indicator process 10 may allow user 46 to define an override. For example, user 46 may select, via onscreen pointer 208 (which may be controlled by a pointing device, such as a mouse; not shown) relationship user Tom from contacts list 150. Selecting Tom may result in availability indicator process 10 (alone or in conjunction with instant messaging client application 22) rendering pop-up menu 210. While pop-up menu 210 is shown only including two options (namely “always indicate status” and “never indicate status”), this is for illustrative purposes only, as the number and nature of the options included within pop-up menu 210 may vary according to design criteria and user need.

User 46 may select, via onscreen pointer 208, “always indicate status” from within pop-up menu 210. Selecting “always indicate status” may result in availability indicator process 10 defining 112 Tom as being capable of viewing the instant messaging availability status of user 46 notwithstanding an associated 106 relationship score. Similarly, user 46 may select “never indicate status” from within pop-up menu 210. Selecting “never indicate status” from within pop-up 210 may result in availability indicator process 10 defining 114 Tom as being restricted from viewing the instant messaging availability status of user 46. As such, availability indicator process 10 may allow user 46 to manage the relationship users having the ability to view user 46's availability status.

While many of the above-described aspects, such as indicating 108 an instant messaging availability status of the user to the one or more relationship users based upon, at least in part, the relationship score of the one or more relationship users, have been described in terms of being specific to a given user, it should be appreciated that such features, (e.g., predefined preferences for associating 106 a relationship score with one or more relationship users) may be implemented across a communication system. For example, an availability indicator process 10 may define 110 a threshold relationship score to be applied system-wide for all, or at least a portion of, the relationship users of the system. As such, the organization may define 110 a threshold relationship score for all relationship users capable of viewing the instant messaging availability status of other relationship users within the organization.

Additionally, while relationship scores are discussed generally in the context of higher relationship scores being the qualifier for viewing the instant messaging availability status of a user, a low relationship score may be the qualifier for viewing the instant messaging availability status of a user and those relationship users with high relationship scores may be excluded.

Further, while the plurality of relationships of the user are described as the bases for associating 106 a relationship score to relationship users, whether the user responded to or otherwise acknowledged the plurality of relationships may be used in determining and associating 106 the relationship score for relationship users. For example, if a user received an email from a co-worker and reviewed it, but elected not to respond, the relationship score may be weighted and/or adjusted accordingly.

A number of implementations have been described. Nevertheless, it will be understood that various modifications may be made. Accordingly, other implementations are within the scope of the following claims.

What is claimed is:

1. A method comprising:
analyzing a plurality of relationships of a user;
defining a social network of the user based upon, at least in part, at least a portion of the plurality of relationships, the social network identifying one or more relationship users;
associating a relationship score with the one or more relationship users; and
indicating an instant messaging availability status of the user to the one or more relationship users based upon, at least in part, the relationship score associated with the one or more relationship users.

2. The method of claim 1, wherein the plurality of relationships of the user include one or more of: email communications, instant messaging chats, web conferences, project collaborations, voice communications, scheduled calendar events, and travel itineraries.

3. The method of claim 1, wherein the relationship score is based upon, at least in part, one or more predefined preferences defined by one or more of the user and an administrator.

4. The method of claim 1, wherein the relationship score is based upon, at least in part a temporal parameter associated with each of the plurality of relationships of the user.

5. The method of claim 4, wherein the temporal parameter associated with each of the plurality of relationships of the user is defined in terms of one or more of days, weeks, months, and years.

6. The method of claim 1, wherein the relationship score is based upon, at least in part, a weighting factor for the plurality of relationships of the user.

7. The method of claim 1, further including defining by the user, a threshold relationship score, and indicating the instant messaging availability status of the user if the relationship score associated with the one or more relationship users is greater than the threshold relationship score.

8. The method of claim 1, further including defining one or more relationship users capable of viewing the instant messaging availability status of the user notwithstanding an associated relationship score.

9. The method of claim 1, further including defining one or more relationship users restricted from viewing the instant messaging availability status of the user notwithstanding an associated relationship score.

10. The method of claim 1, further including:
updating the relationship score of the one or more relationship users; and
indicating the instant messaging availability status of the user to the one or more relationship users based upon, at least in part, the updated relationship score of the one or more relationship users.

11. A computer program product residing on a computer readable medium having a plurality of instructions stored thereon which, when executed by a processor, cause the processor to perform operations comprising:
analyzing a plurality of relationships of a user;
defining a social network of the user based upon, at least in part, at least a portion of the plurality of relationships, the social network identifying one or more relationship users;
associating a relationship score with the one or more relationship users; and
indicating an instant messaging availability status of the user to the one or more relationship users based upon, at least in part, the relationship score associated with the one or more relationship users.

12. The computer program product of claim 11, wherein the plurality of relationships of the user include one or more of: email communications, instant messaging chats, web conferences, project collaborations, voice communications, scheduled calendar events, and travel itineraries.

13. The computer program product of claim 11, wherein the relationship score is based upon, at least in part, one or more predefined preferences defined by one or more of the user and an administrator.

14. The computer program product of claim 11, wherein the relationship score is based upon, at least in part a temporal parameter associated with each of the plurality of relationships of the user.

15. The computer program product of claim 14, wherein the temporal parameter associated with each of the plurality of relationships of the user is defined in terms of one or more of days, weeks, months, and years.

16. The computer program product of claim 11, wherein the relationship score is based upon, at least in part, a weighting factor for the plurality of relationships of the user.

17. The computer program product of claim 11, further including defining by the user, a threshold relationship score, and indicating the instant messaging availability status of the user if the relationship score associated with the one or more relationship users is greater than the threshold relationship score.

18. The computer program product of claim 11, further including defining one or more relationship users capable of viewing the instant messaging availability status of the user notwithstanding an associated relationship score.

19. The computer program product of claim 11, further including defining one or more relationship users restricted from viewing the instant messaging availability status of the user notwithstanding an associated relationship score.

20. The computer program product of claim 11, further including:
updating the relationship score of the one or more relationship users; and
indicating the instant messaging availability status of the user to the one or more relationship users based upon, at least in part, the updated relationship score of the one or more relationship users.
